(19) United States
(12) Patent Application Publication
(10) Pub. No.: US 2006/0137689 A1
(43) Pub. Date: Jun. 29, 2006

(54) Breathing protective device

(76) Inventor: Anders Evensson, Molkom (SE)

Correspondence Address: MANELLI DENISON & SELTER, 2000 M STREET NW SUITE 700, WASHINGTON, DC, 20036-3307, US

(21) Appl. No.: 10/533,587

(22) PCT Filed: Nov. 4, 2003
(86) PCT No.: PCT/SE03/01694

§ 371 Date: Dec. 12, 2005

(30) Foreign Application Priority Data
Nov. 5, 2002 (SE) 0203242-3

(51) Int. Cl. A62B 23/02; A62B 7/10

(52) U.S. Cl. 128/205.27; 128/201.25; 128/206.15; 128/206.17; 128/206.29

(57) ABSTRACT

A breathing protective device comprises a filter house body (1) having a filter house (8) with a filter house chamber (40) and a first wall section (45) having a number of through holes (47, 47a), at least one filter (2) in the filter house chamber inside said first wall section, and a mouthpiece (9) arranged to be introduced into and held in the user's mouth and having an air passage between an opening (53) in a second wall section (46) in the filter house (8) and an opening (54) at the end that is to be introduced into the user's mouth. The distinguishing features are that the filter house (8) has a first end (5), a second end (7) and said first and second wall section (45, 46) that extend between said ends of the filter house, that the filter house is elongated and extends parallel to a line between the corners of the user's mouth when the mouthpiece is inserted in the user's mouth, that said first wall section of the filter house is provided with a plurality of through holes (47, 47a) in at least one area and that it extends at least essentially straight in the longitudinal direction of the house at least on the inside in at least the area or areas in which said through holes are arranged, that the filter is arranged in the filter house chamber, along said second wall section and covering the openings in this wall section, that a non return valve (3, 33) that is closed at inhalation and opened at exhalation is arranged in at least said first end, and that at least one passage (40) for exhalation air extends between the opening in the first wall of the filter house and said non return valve at the first end of the filter house.

### TECHNICAL FIELD

The invention relates to a breathing protective device comprising a filter house body having a filter house with a filter house chamber and a first wall section having a number of through holes, at least one filter in the filter house chamber inside said first wall section and a mouthpiece arranged to be introduced into and held in the user's mouth and having an air passage between an opening in a second wall section in the filter house and an opening at the end that is to be introduced into the user's mouth.

### BACKGROUND OF THE INVENTION

Breathing protective devices used today are either very advanced but conventional gas masks, or more simple breathing protective devices that cover the mouth and nose. Gas masks have their given field of use in extremely dangerous environments that require advanced air purification. Simple, conventional breathing protective devices that cover the mouth and nose are widely used for lack of anything else, in environments also requiring air purification, despite such devices being uncomfortable and in many cases having insufficient purification ability and other drawbacks.

Breathing protective devices of the type mentioned in the introduction above have also been suggested. As examples of such breathing protective devices reference can be made to those described in WO 92/21408, EP 0 695 561 A1, U.S. Pat. No. 5,771,885, U.S. Pat. No. 5,957,131 and DE-OS 2 115 715. However, all protective devices shown in these publications have deficiencies and/or drawbacks and have as far as the applicant is aware not come to any wide use.

### BRIEF ACCOUNT OF THE INVENTION

Given the above background, the invention aims at providing a breathing protective device of the type mentioned in the introduction above, which in combination with a nose clip, nose plugs or similar will provide for a perfectly satisfactory protection in many work environments and that has many practical advantages in addition. More specifically, the invention aims at providing a breathing protective device that fulfils most of the following advantages and/or requirements:
A good purifying effect
A small breathing resistance both at inhalation and at exhalation
A small size (pocket-size)
A low weight
No interference with the users visual field; not having any far projecting parts
Can be used by persons having a mustache or beard
Standard filters can be used
Can be rationally produced
The filter is easy to insert and remove for exchange or cleaning
A large degree of utilization of space available for air purification
Can be used with different filter grades adapted to the requirements of the environment of use
Does not require a special cassette for insertion and removing of the filter
By a small modification, the same basic design can be used also to clean exhalation air, e.g. to filter micro-organisms from the exhalation air.

All, or at least most of the qualities mentioned above can be attained by a breathing protective device of the type mentioned in the introduction, characterised in
that the filter house has a first end, a second end and said first wall section that extends between said ends of the filter house,
that the filter house is elongated and extends parallel to a line between the corners of the user's mouth when the mouthpiece is inserted in the user's mouth,
that said first wall section of the filter house is provided with a plurality of through holes in at least one area and that it extends at least essentially straight in the longitudinal direction of the house at least on the inside in at least the area or areas in which said through holes are arranged,
that the filter is arranged in the filter house chamber, along said second wall section and covering the openings in this wall section,
that a non return valve that closes at inhalation and opens at exhalation is arranged in at least said first end, and
that at least one passage for exhalation air extends between the opening in the first wall of the filter house and said non return valve at the first end of the filter house.

Additional characteristics and aspects of the invention are apparent from the claims and from the following detailed description of the invention.

### BRIEF DESCRIPTION OF THE DRAWINGS

In the detailed description of the invention, reference will be made to the enclosed drawings, of which

FIG. 1 shows a planar view of a filter of a type that can be used in the breathing protective device according to the invention,

FIG. 2 is a side elevation view of the filter along a line II-II in FIG. 1,

FIG. 3 is an exploded view in perspective showing the different components that are part of the breathing protective device according to a preferred embodiment of the invention,

FIG. 5 is an end elevation view of the filter house along a line V-V in FIG. 3,

FIG. 6 shows the assembled breathing protective device in a side elevation view in a direction towards a rear mouthpiece opening,

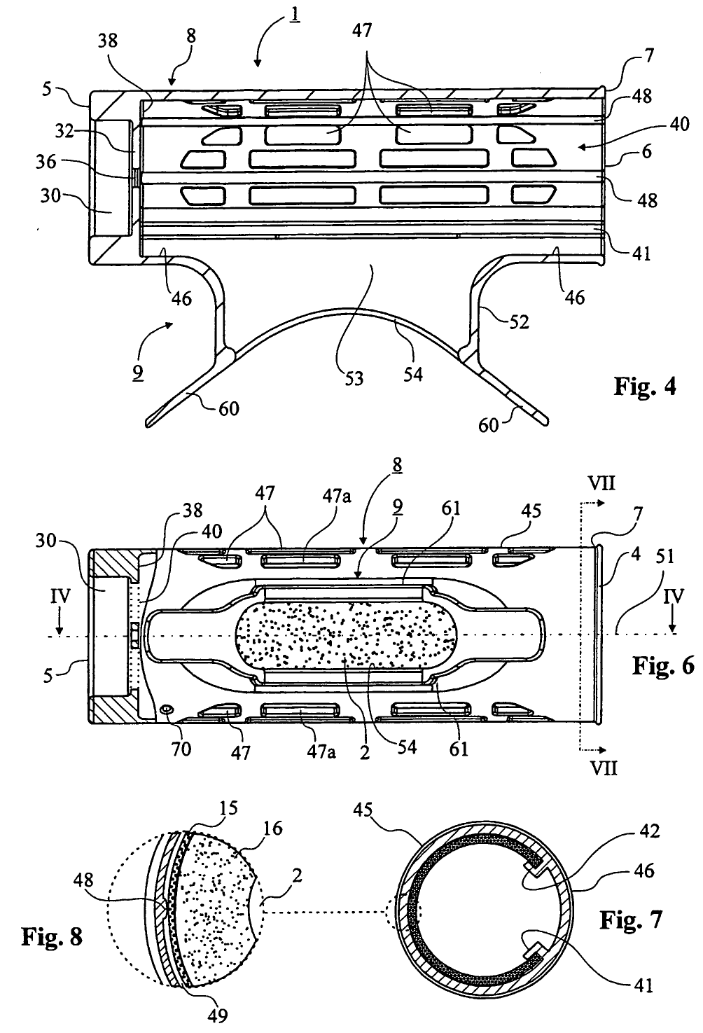

FIG. 4 shows the breathing protective device in side elevation along the line IV-IV in FIG. 6, and

FIG. 8 shows an encircled part of FIG. 7 in a larger scale, and FIG. 7 in turn shows the cross section VII-VII of FIG. 6.

### DETAILED DESCRIPTION OF THE INVENTION

According to the preferred embodiment of the invention, a breathing protective device consists of a filter house body 1 having a filter house 8, a filter 2 that can be introduced into the filter house 8, a valve body 3 and a cover 4. The valve body 3 is arranged to be mounted at a first end 5 of the filter house 8. The filter 2 can be introduced into the filter house 8, via an opening 6 at the second end 7 of the filter house, and the cover 4 is intended to seal the opening 6 when the filter 2 has been introduced.

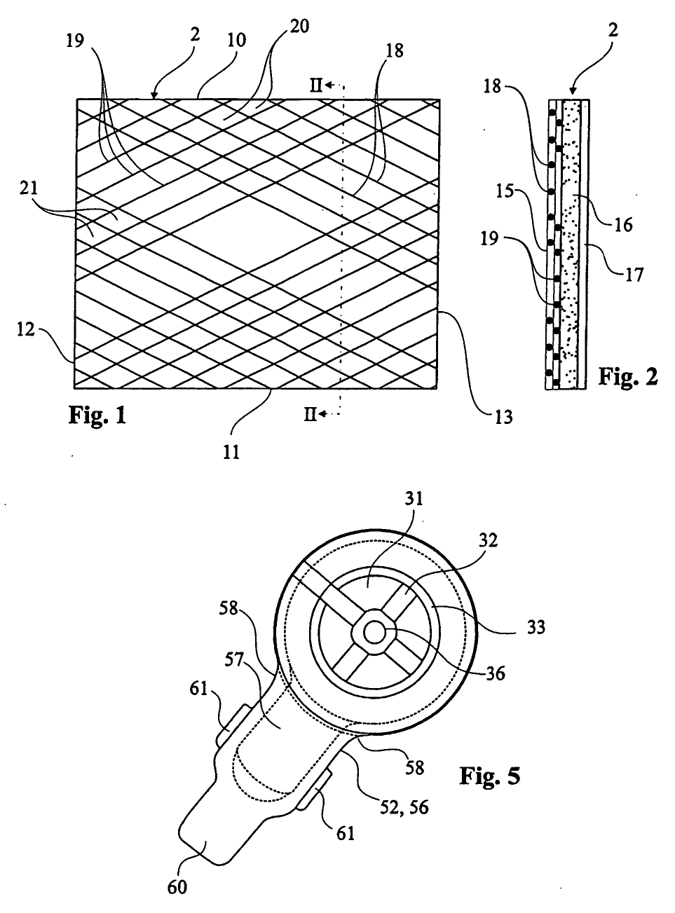

FIGS. 1 and 2 show the filter 2 in an initial position, before it has been introduced into the filter house 8. In this form, it consists of a small rectangular sheet (the terms plate or cloth can also be chosen for an object of this type), having a length of 90 mm, a width of 65 mm and a thickness of about 5 mm. A pair of longitudinal side edges have been denoted 10, 11 and a pair of opposite end edges have been denoted 12 and 13, respectively. The sheet has been punched or cut out from a larger sheet of a type of multilayered filter cloth that is manufactured by Hullingsworth & Vose Filtration Ltd, England, under the trade name Technostat, 200 gr/m². The filter 2 used according to the preferred embodiment is accordingly a filter cloth of standard type, that is widely used in fixed filters at industrial premises, in vacuum cleaners etc. This filter cloth, and thereby also the filter 2, consists of an outer, relatively rigid but pliable, flexible supporting layer 15 of a coarse plastic net, inside of that a filter stuff 16 of soft, fibrous, mixed synthetic material, and innermost at the suction side a very thin screen cloth 17 of spun polypropylene, that prevents fluff from the filter stuff 16 to come loose and be sucked into the user's mouth. The net-shaped supporting layer 15 is manufactured from thin, crossed strands of plastic that are positioned on top of each other but not braided together. More specifically, the net-shaped supporting layer 15 has upper strands 18 and lower strands 19, the latter bearing against the filter stuff 16 that forms the actual filtering layer. This also means that all openings 20 between each pair of adjacent outer strands 18 are in direct communication with each other, and that essentially all openings 21 between each pair of lower strands 19 also are in communication with each other, which is not without significance to the distribution of the air that is sucked into the filter stuff/filtering layer 16.

The described type of filter, having the trade name Technostat, 200 gr/m² is suitable when the breathing protective device according to the invention is to be used e.g. in dusty construction sites or by persons having allergy troubles for e.g. canine, feline or bovine hair or pollen. In environments containing cement powder, stone and/or carbon dust, a filter stuff should be used that is finer than the one in Technostat, 200 gr/m², in which case the filter however may have the same design as the described one and be manufactured by the company mentioned above or some other manufacturer. In principle, still finer filter stuffs can be used in the filter that is part of the breathing protective device according to the invention, e.g. filter stuffs containing activated carbon, ion-exchanger materials or other absorbents or adsorbents for uptake of gaseous or vaporous pollutants, as well as welding fume and other fumes.

The filter house body 1 is an integrated unity of moulded plastics consisting of said filter house 8 and a mouthpiece unit 9. The filter house 8 is shaped as an elongated, circular-cylindrical tube that extends between said first end 5 and said second end 7 with an opening 6 that can be covered by the cover 4. In this embodiment, the filter house 8, including the cover 4, has a total length of 100 mm, an outer diameter of 33 mm and a wall thickness of about 2 mm.

A central, cylindrical recess 30 is arranged at the first end 5 of the filter house 8, FIG. 4 and FIG. 6. At the bottom of the recess 30, there are four openings 31 for exhalation air and shaped as circular sectors, between four radial spars 32. Around the bottom of the circumference of the recess 30, there is also an annular shelf 33. The spars 32 and the annular shelf 33 together form a seat for the valve body 3 that consists of a rubber membrane. At the centre of the rubber membrane there is a pin 34 and at the end of the pin there is a knob 35 that can be snapped into a central hole 36 at the bottom of the recess 30 to fix the valve body 3 in said recess. This valve design is of a standard type used in e.g. diving gears. At inhalation, this non return valve is sealed by the membrane 3, having a diameter corresponding to the diameter of the recess 30, sealing against the shelf 33 and also resting against the spars 32.

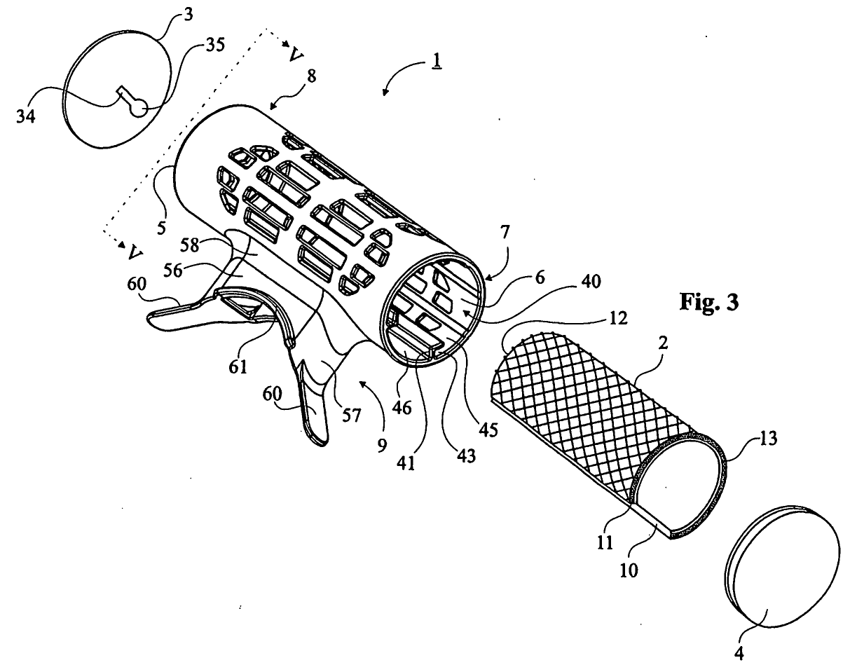

A filter house chamber 40 is arranged in the filter house 8. At the inside of the filter house 8, there are two fins 41, 42 that initially extend radially inwards from the filter house wall, in order then to bend off at straight angle in opposite directions from each other. The arc distance between the fins 41 and 42 comprises a circular sector angle of 90°. The fins 41, 42 extend along the entire length of the filter house chamber 40, from said annular bottom 38 at the first end 5 of the filter house 8, to the opening 6 at the second end 7 of the house. The fins 41, 42 form rails that constitute attachment means for the filter 2 that can be fixed in the grooves 43 formed by the angled fins 41, 42 in combination with the wall on the filter house. These fins/rails/attachment means 41, 42 also form a border between a first, front wall section 45 in the filter house 8, which first wall section 45 extends ahead from the first attachment means 41 and around the filter house 8 to the second attachment means 42, thus forming a 270° long circular arc, and a second, rear wall section 46, comprising said circular arc of 90°. When the filter 2 is mounted, it is manually shaped to the approximate shape shown in FIG. 3, with the supporting layer 15 outwards turned, where after the filter 2 is inserted through the opening 6 and into the filter house 8, whereby the longitudinal edges 11, 12 of the filter 2 are inserted into the grooves 43 of the attachment means 41, 42. Thereafter, the filter 2 is pushed all the way through the filter house 8 with the edges 11, 12 sliding in the grooves 43, until the first end edge 12 of the filter 2 abuts the annular bottom 38 at the first end 5 of the filter house. Then, the second end edge 13 of the filter 2 will be flush with the second end 7 of the filter house, or project a few millimetres from the opening 6. When the cover 4 is applied, it will accordingly bear against the edge 13 of the filter at the same time as the longitudinal edges 10, 11 bear against the bottom of the grooves 43 of the attachment means 41, 42.

In the first wall section 45, a plurality of holes 47 are provided for air to be sucked in and purified in the filter 2 that is arranged in the filter house chamber 40 in the area of said first wall section 45. On the inside of the filter house 8, there is in said first wall section 45 also a number of longitudinal projections 48 on the filter house wall. They extend along the entire length of the filter house and are five in number. As is shown in FIGS. 3 and 6, the holes 47 in the filter house wall are arranged in longitudinal rows. The longitudinal projections 48 are arranged between every second of these rows. The height of the projections 48 is about 0.3 mm, which is enough to form a narrow slit 49 between the filter house wall and the filter 2. In the space 49, the air that is sucked in via the openings 47 is distributed before the air is sucked further in, through the filter 2. The supporting layer 15 of the filter may, by its above described design, also contribute to an effective distribution of air on the air suction side of the filter stuff/filtering layer 16. The filter 2, that is fixed in the attachment means 41, 42, is, by the resiliency in the supporting layer 15, pressed against the filter house wall, a priori against the longitudinal projections 48 around the entire circular arc shaped inside of the first wall section 45. The longitudinal edges 10, 11 of the filter are pressed against the bottom 43 in the attachment means 41, 42 and are in that way sealed, while the end edges 12, 13 are sealed against the annular end wall 38 at the first end 5 of the filter house, and against the inside of the cover 4 at the second end 7, respectively.

The mouth piece unit 9 is connected to the filter house 8 in the area of the second wall section 46 of the filter house, centrally on this wall section, so that the filter house 8 projects equally far to the left as to the right from the mouth piece unit. According to the embodiment, the mouth piece unit 9 has a symmetry plane 51 that coincides with a longitudinal symmetry plane for the filter house 8. The mouth piece 9 comprises a tubular section 52, that forms a canal from a front opening 53 in the second wall section 46 of the filter house to a rear, elongated opening 54. The opening 53 in the filter house wall is somewhat wider, as is apparent from FIG. 4. The tubular section 52 is elongated in the symmetry plane 51. The longitudinal side walls 56 are flat and parallel, while the end walls 57 are rounded, FIG. 3. The connection 58 to the filter house 8 is softly rounded up to all walls of the tubular section 52. From the opening 53, the filter house 8 projects about the same length in both directions.

The mouth piece 9 has a pair of wings 60, that extend obliquely backwards and outwards from the rear end of the tubular section 52. These wings are inserted into the user's mouth and will then bear against the cheeks in the oral cavity. Thanks to the elongated extension of the tubular section, the rounded end walls 57 of the tubular section will furthermore bear against the corners of the mouth at the same time as the lips grip the tubular section and a pair of arched flanges 61, one on each side of the opening 54 at the rear end of the planar walls 56. Furthermore, the mouth piece with the tubular section 52 has such a length that the lips will bear against the rounded transition 58 to the filter house 8, close to but not covering the openings 47a that are positioned closest to the mouth piece 9. By the described elongated shape of the tubular section 52 of the mouth piece 9, the rounded end walls 52 are forced to locate themselves in the corners of the user's mouth, which in turn leads to that the entire filter house body 1 is oriented in a desired way, namely so that the filter house 8 will extend horizontally crosswise in front of the user's mouth, with sections of the filter house projecting sideways in both directions, past the corners of the mouth. In a direction forwards from the mouth, the filter house 1 and thus the entire breathing protective device only projects a distance corresponding approximately to the diameter 9 of the filter house, i.e. only just under 35 mm according to the embodiment, which is a considerable advantage in many work situations.

The described breathing protective device has such shape and according to the embodiment also such dimensions that it can be kept in a small bag, that can be attached e.g. to a belt, or even in a pocket in the work-clothes of the user. When the breathing protective device is to be used, the mouth piece 9 is inserted into the user's mouth, as is described above, while the nostrils are sealed in a conventional way, e.g. by a nose clip that can be attached in a hole 70 in the valve house wall, when the breathing protective device is not used. When the user inhales, the non return valve at the first end 5 of the valve house 8 seals by the membrane 3 sealing against the circumferential shelf 33 in the recess 30, at the same time as it is brought to bear against the spars 32. Air is sucked in via the openings 47, 47a and is distributed in the slit 49 on the inside of the filter house wall in the first wall section 45, before the air continues to be sucked in through the filter stuff/filtering layer 16 and further into the space inside the filter 2 in the filter house chamber 40. From there, the air continues through the opening 53, the tubular section 52 and the rear opening 54 in the mouthpiece, and into the user. The breathing resistance caused by the breathing filter is small, especially in relation to the small dimensions of the breathing protective device. This is due to the filter 2 having a comparatively large surface, that can be fully used by an optimal utilisation of the design and geometry of the breathing protective device. The efficient distribution over the filter surface, of the air that is sucked in, also promotes a low breathing resistance. At exhalation, the breathing resistance of the breathing protective device is virtually negligible. The air channels that consist of the tubular section 52 and of the filter house chamber 40 inside the filter 2 are very wide; the membrane 3 opens up at an extremely low overpressure and also, the air discharge openings 31 at the first end 5 of the filter house are wide enough not to cause any noticeable resistance.

It should be realised that the design of the breathing protective device is not limited to the embodiment described, but may be varied within the scope of the enclosed claims. Accordingly, the filter house 8 e.g. may be of another shape than a circular cylindrical tube, e.g. a tube with an orthogonal cross-section. However, the circular cylindrical shape ought to be ideal. It is also conceivable to angle the connecting tubular piece 52 downwards, so that the filter house 1 will be positioned at a lower lever, somewhat below the opening of the mouth. This would however increase the entire size of the breathing protective device, which is a drawback. Furthermore, the openings 47, 47a in the filter house wall can of course be given another shape and size than the shown one, without impairing the function of the breathing protective device in any way, given that the total area of the inlet openings is not decreased too much. It should also be mentioned that the filter 2 can be of another type than the described one. Instead of being pliable and able to be formed from a planar piece, it may accordingly be stiff and have the shape it should have in a functional position in the filter house chamber, something that in certain cases possibly may be a prerequisite for it to be used in certain types of filter stuffs. In principle, the filter 2 may be arranged in a cassette, even though it is a clear advantage not having to use such an extra component but instead avoiding any type of cassette or the similar, which the embodiment constitutes an example of. Another alternative is to make the filter non-exchangeable, so that the entire breathing protective device is exchanged when it is considered to be consumed. Hereby, the filter is preferably integrated (e.g. in connection with moulding) in the filter house, during the manufacturing process.

1-19. (canceled)

20. A breathing protective device comprising a filter house body having a filter house with a filter house chamber and a first wall section having a number of through holes, at least one filter in the filter house chamber inside said first wall section, and a mouthpiece arranged to be introduced into and held in the user's mouth and having an air passage between an opening in a second wall section in the filter house and an opening at the end that is to be introduced into the user's mouth:
wherein the filter house has a first end, a second end and said first and second wall section that extend between said ends of the filter house, the filter house is elongated and extends parallel to a line between the corners of the user's mouth when the mouthpiece is inserted in the user's mouth, said first wall section of the filter house is provided with a plurality of through holes in at least one area and that it extends at least essentially straight in the longitudinal direction of the house at least on the inside in at least the area or areas in which said through holes are arranged, the filter is arranged in the filter house chamber, along said second wall section and covering the openings in this wall section, a non return valve that is closed at inhalation and opened at exhalation is arranged in at least said first end, and at least one passage for exhalation air extends between the opening in the first wall of the filter house and said non return valve at the first end of the filter house.

21. A breathing protective device according to claim 20, wherein said first wall section of the filter house has an inside that is essentially straight in the longitudinal direction of the filter house but arched, bent or angled in a plane that is perpendicular to the longitudinal direction.

22. A breathing protective device according to claim 20, wherein the inside of said first wall section defines a cylindrical segment of the filter house chamber, that extends along at least the major part of the length of the filter house chamber and around at least the major part of its circumference, from a first position on one side of the opening in said second wall section, around the inside of said first section to a second position on the other side of said opening.

23. A breathing protective device according to claim 20, wherein the length of the inner circumference of the first wall section is longer than the circumference of the wall section in the areas between the opening of this end section and said ends.

24. A breathing protective device according to claim 21, wherein the inside of said first wall section is essentially circular cylindrical.

25. A breathing protective device according to claim 20, wherein attachment means for the filter are arranged on the inside of the filter house.

26. A breathing protective device according to claim 25, wherein said attachment means are arranged at said first and second positions on either side of and preferably close to the opening in said second wall section.

27. A breathing protective device according to claim 26, wherein the attachment means for the filter are designed as rails that, connected to the filter house wall, extend in the longitudinal direction of the filter house, along the entire length of said first wall section, and form longitudinal boundaries for this wall section and at the same time form seals against the longitudinal edges of the filter.

28. A breathing protective device according to claim 27, wherein the longitudinal edges of the filter are arranged in grooves in said attachment means.

29. A breathing protective device according to claim 20, wherein the filter, when mounted in the filter house chamber, has an outside contour that essentially follows the inside contour of the first wall section of the filter house.

30. A breathing protective device according to claim 29, wherein the filter is fixed between said attachment means to bear against or almost bear against the inside of the first wall section of the filter house.

31. A breathing protective device according to claim 30, wherein the filter comprises both a filtering layer that contains a filter stuff and a supporting layer that is flexibly pliable and relatively stiff and has a plurality of openings arranged close to each other, which supporting layer forms a first distance means between the filter house wall and the filtering layer.

32. A breathing protective device according to claim 31, wherein the first wall section of the filter chamber is on its inside provided with a plurality of low height projections that form second distance means between the filter house wall and the filtering layer.

33. A breathing protective device according to claim 31, wherein each opening in the supporting layer communicates with another opening in the supporting layer, such that a distribution of the air can be promoted thereby, before the air is sucked into the filtering layer.

34. A breathing protective device according to claim 32, wherein the supporting layer is designed as a relatively coarse mesh plastic net formed of upper and lower, crossed strands.

35. A breathing protective device according to claim 20, wherein a recess is provided at said first end, on the outside of the filter house, and in that the non return valve is recessed and fixed in this recess.

36. A breathing protective device according to claim 20, wherein an end wall section is provided at the first end of the filter house, all around the inside of the filter house, against which end wall section one end edge of the filter bears.

37. A breathing protective device according to claim 35, wherein a seat for a membrane included in said non return valve is provided at the bottom of the recess at said first end.

38. A breathing protective device according to claim 20, wherein a detachable cover covers an opening at the second end of the filter house, the filter via said opening can be inserted in the filter house chamber, and the inside of the cover bears against the second end wall of the filter, after it has been put back over the opening.
